(19) United States
(12) Patent Application Publication
(10) Pub. No.: US 2007/0196659 A1
(43) Pub. Date: Aug. 23, 2007

(54) Carbon gel composite material

(75) Inventors: Norihiko Setoyama, Aichi-ken (JP); Tsutomu Kajino, Toyoake-shi (JP); Hideki Takagi, Aichi-ken (JP); Takahiko Asaoka, Nagoya-shi (JP); Yoshiaki Fukushima, Aichi-ken (JP)

Correspondence Address: DARBY & DARBY P.C., P.O. BOX 770, Church Street Station, New York, NY, 10008-0770, US

(73) Assignee: KABUSHIKI KAISHA TOYOTA CHUO KENKYUSHO, Aichi-ken (JP)

(21) Appl. No.: 11/218,285

(22) Filed: Aug. 31, 2005

(30) Foreign Application Priority Data
Aug. 31, 2004 (JP) 2004-251669

(51) Int. Cl. B32B 9/00; C01B 31/08

(52) U.S. Cl. 428/408

(57) ABSTRACT

A carbon gel composite material including: a carbon gel which is composed of primary particles with an average particle diameter of 2 to 50 nm, where no x-ray diffraction peaks are observed over a scan angle (2θ) range of 0.5 to 10° (CuK₆₀ radiation) and where in a pore size distribution calculated from an adsorption/desorption isotherm, if a pore diameter corresponding to the peak of the pore size distribution is not smaller than 1 nm and is smaller than 10 nm (pore diameter (d)), pores accounting for 60% or more of the total pore volume have a pore diameter within plus or minus 2 nm of the pore diameter (d), and if a pore diameter corresponding to the peak of the pore size distribution is in a range of 10 to 50 nm (pore diameter (D)), pores accounting for 60% or more of the total pore volume have a pore diameter in a range of (0.75×D) to (1.25×D); and at least one adsorbed component selected from the group consisting of proteins, metal complexes and metals, which is adsorbed on the carbon gel.

### BACKGROUND OF THE INVENTION

1. Field of the Invention

The present invention relates to a composite material containing a carbon gel as a carrier.

2. Related Background Art

There have been various studies on porous materials and it has been contemplated that they would be applied as carriers used for catalysts, electrode materials and the like through use of their adsorptivity. Various types of porous materials are known, which are used for such purposes, and one typical example of such porous materials includes activated carbon.

Such activated carbon is a porous material with a framework formed of carbon atoms, and has a high specific surface area.

Conventionally, a high specific surface area was obtained by performing activation process in the production process in order to form pores on the surface of the material which is processed into activated carbon. For such an activation process, for example, the following processes are known: heating a raw material to 600-1000° C. in steam or in the atmosphere of carbon dioxide or the like; or mixing zinc chloride, potassium hydroxide or the like with a raw material and heating it under inert atmosphere. Through the activation process, multiple pores are formed on the surface of the material to be processed into activated carbon, thereby providing activated carbon with a high specific surface area. However, most of such pores have a diameter of 1 nm or less. For this reason, there is a limit to increase adsorptivity only by increasing the specific surface area, and thus satisfactory porous material has yet to be obtained.

In recent years, mesoporous carbon with so-called mesopores has been developed. “Adsorption of Cytochrome C on New Mesoporous Carbon Molecular Sieves”, A. Vinu et al., J. Phys. Chem B, 2003, Vol. 107, p. 8297-8299 (Document 1) discloses that cytochrome C is adsorbed on mesoporous carbon molecular sieves.

However, even when mesoporous carbon molecular sieves as described in Document 1 are used as a carrier, there is a limit to increase the stability and activity of components adsorbed therein. Thus, satisfactory porous materials have yet to be obtained.

### SUMMARY OF THE INVENTION

The present invention was accomplished in light of the foregoing problems of the prior art, and it is an object of the present invention to provide a carbon gel composite material that carries a high amount of components such as protein, metal complex or metal and that provides adsorbed components with an excellent stability and activity, the carbon gel composite material being useful as catalysts and the like.

The present inventors have diligently conducted studies in order to accomplish the foregoing object. As a result, they have found that it is possible to achieve the forgoing object through the use of a carbon gel as a carrier, which is composed of primary particles with an average particle diameter of 2 to 50 nm and has a highly uniform pore diameter, where pores are not periodically arranged but constitute a three-dimensional network structure in which they are connected to each other. In this way, they have completed the present invention.

The present invention is a carbon gel composite material including: a carbon gel which is composed of primary particles with an average pore diameter of 2 to 50 nm, where no x-ray diffraction peaks are observed over a scan angle (2θ) range of 0.5 to 10° (CuK_{α}radiation) and where in a pore size distribution calculated from an adsorption/desorption isotherm, if a pore diameter corresponding to the peak of the pore size distribution is not smaller than 1 nm and is smaller than 10 nm (pore diameter (d)), pores accounting for 60% or more of the total pore volume have a pore diameter within plus or minus 2 nm of the pore diameter (d), and if a pore diameter corresponding to the peak of the pore size distribution is in a range of 10 to 50 nm (pore diameter (D)), pores accounting for 60% or more of the total pore volume have a pore diameter in a range of (0.75×D) to (1.25×D); and

at least one adsorbed component selected from the group consisting of proteins, metal complexes and metals, which is adsorbed on the carbon gel.

In the carbon gel composite material of the present invention, the pore diameter of the carbon gel, corresponding to the peak of the pore size distribution, is preferably in a range of 1 to 20 nm.

Moreover, in the present invention the pore diameter of the carbon, corresponding to the peak of the pore size distribution, is preferably 1 to 1.25 times the average molecular diameter of the adsorbed component.

Furthermore, the specific surface area of the carbon gel is preferably 100 m²/g or more, and the total pore volume of the carbon gel is preferably 0.1 to 50 ml/g.

In addition, as the protein to be adsorbed on the carbon gel according to the present invention, at least one protein selected from the group consisting of oxidoreductases and electron transfer proteins is preferable.

Furthermore, at least a near-surface portion of the carbon gel which is used for the carbon gel composite material of the present invention may be composed of nitrogen-containing carbon. In this case, the ratio of nitrogen atoms to carbon atoms (N/C) in the nitrogen-containing carbon is preferably 0.01 to 0.4.

According to the present invention, it is possible to provide a carbon gel composite material that carries a high amount of components such as protein, metal complex or metal and that provides adsorbed components with excellent stability and activity, the carbon gel composite material being useful in various applications as diverse as catalysts.

### BRIEF DESCRIPTION OF THE DRAWINGS

FIG. 1 is a graph showing the pore size distribution of carbon gels prepared in the Synthesis Examples 1 to 4.

FIG. 2 is a graph showing the specific activities of the carbon composite material prepared in the Example 1 and of the mesoporous carbon composite material prepared in the Comparative Example 1.

FIG. 3 is a graph showing the pore size distributions of carbon gel and carbon black used in Example 2.

FIG. 4 is a graph showing the result of discharge test of compact fuel cells obtained in the Examples 2 and 3 and Comparative Examples 2 and 3.

FIG. 5 is a graph showing the result of oxidation-reduction reaction test of catalysts obtained in the Examples 4 to 6 and Comparative Example 5.

### DETAILED DESCRIPTION OF THE PREFERRED EMBODIMENTS

Hereinafter, the present invention will be described in line with a preferred embodiment. However, the present invention is not limited to the following embodiment.

(Carbon Gel)

The carbon porous material used as a carrier in the present invention meets the following conditions (i) to (iii):

(i) Upon X-ray diffraction (XRD) measurement, no x-ray diffraction peaks are observed over a scan angle (2θ) range of 0.5 to 10° (CuK₆₀ radiation);

(ii) The carbon porous material is composed of primary particles with an average particle diameter of 2 to 50 nm; and

(iii) In a pore size distribution calculated from an adsorption/desorption isotherm, if a pore diameter corresponding to the peak of the pore size distribution is not smaller than 1 nm and is smaller than 10 nm (pore diameter (d)), pores accounting for 60% or more of the total pore volume have a pore diameter within plus or minus 2 nm of the pore diameter (d), and if a pore diameter corresponding to the peak of the pore size distribution is in a range of 10 to 50 nm (pore diameter (D)), pores accounting for 60% or more of the total pore volume have a pore diameter in a range of (0.75×D) to (1.25×D).

Here, the presence of X-ray diffraction peaks means that a periodical structure, corresponding to the d value of the peak angle, is present in samples. Accordingly, a carbon porous material where one or more peaks are observed over a scan angle (2θ) range of 0.5 to 10° (CuK₆₀ radiation) is so-called mesoporous carbon (MPC) with a structure in which pores are arranged at regular intervals of 0.9-17.7 nm. When such mesoporous carbon is used as a carrier, it is impossible to achieve sufficient increase in the stability and activity of components such as enzyme, which are adsorbed on the carrier.

By contrast, in the carbon gel used in the present invention, no X-ray diffraction peaks are observed over a scan angle (2θ) range of 0.5 to 10° (CuK₆₀ radiation), and the pores in the carbon gel are not arranged periodically but constitute a three-dimensional network structure in which they are connected to each other. Amazingly, in the present invention, employment of such a carbon gel as a carrier for components such as enzyme increases the stability and activity of adsorbed components, although the reason still remains elusive.

In the present invention it should be noted that upon X-ray diffraction (XRD) measurement, X-ray diffraction peaks where the ratio of the peak intensity to the background noise intensity is less than 3 are not regarded as X-ray diffraction peaks. In other words, “no X-ray diffraction peaks are observed over a scan angle (2θ) range of 0.5 to 10° (CuK_{α}radiation)” means that there are no X-ray diffraction peaks observed where the ratio of the peak intensity to the background noise intensity equals to or greater than 3.

The carbon gel according to the present invention is composed of primary particles with an average particle diameter of 2 to 50 nm, more preferably is composed of primary particles with an average particle diameter of 4 to 20 nm. If primary particles constituting the carbon gel have an average particle diameter of less than 2 nm, the size of pores often becomes smaller than that of the adsorbed components, thereby reducing the adsorptivity. Meanwhile, if the average particle diameter exceeds 50 nm, the specific surface area is reduced and thereby the adsorptivity is undesirably reduced.

In addition, the carbon gel according to the present invention is an aggregated matter composed of the primary particles, where in a pore size distribution calculated from an adsorption/desorption isotherm, (iii-1) if a pore diameter corresponding to the peak of the pore size distribution is not smaller than 1 nm and is smaller than 10 nm (pore diameter (d)), pores accounting for 60% or more of the total pore volume have a pore diameter within plus or minus 2 nm of the pore diameter (d), and (iii-2) if a pore diameter corresponding to the peak of the pore size distribution is in a range of 10 to 50 nm (pore diameter (D)), pores accounting for 60% or more of the total pore volume have a pore diameter in a range of (0.75×D) to (1.25×D). If the uniformity of the pore diameter is out of this range, the number of pores with a pore diameter that is not suitable for carrying enzyme and the like will increase, thereby reducing obtainable effects.

Furthermore, the pore diameter of the carbon gel according to the present invention, corresponding to the peak of the pore size distribution, is preferably in a range of 1 to 20 nm. If the pore diameter of the carbon gel is less than 1 nm, the pore size often becomes smaller than that of the adsorbed components, and the adsorptivity is reduced. Meanwhile, if the average pore diameter exceeds 50 nm, the specific surface area is reduced and thereby the adsorptivity is undesirably reduced. Moreover, if the pore diameter exceeds 20 nm, problems tend to occur at the time when the carbon gel adsorbs a certain type of protein.

It should be noted that, for the purpose of preventing the reduction in the amount of adsorbed components, the pore diameter of the carbon gel according to the present invention, corresponding to the peak of the pore size distribution, is preferably larger than the average molecular diameter of the adsorbed components. More preferably, the average pore diameter is about 1 to 1.25 times the average molecular diameter of the adsorbed components.

Moreover, the carbon gel according to the present invention preferably has a specific surface area of 100 m²/g or more, more preferably has a specific surface area of 500 to 1000 m²/g. If the carbon gel has a specific surface area of less than 100 m²/g, the area with which adsorbed components are in contact will be reduced, and the number of pores into which adsorbed components are housed will be reduced. Thus, there is a tendency that the adsorptivity of the carbon gel is reduced.

Furthermore, the total pore volume of the carbon gel according to the present invention is not particularly limited because it also varies depending on the specific surface area and the pore diameter that corresponds to the peak of the pore size distribution. However, the carbon gel according to the present invention preferably has a total pore volume of 0.1 to 50 ml/g, more preferably has a total pore volume of 0.2 to 2.5 ml/g.

The specific surface area and total pore volume of the carbon gel according to the present invention can be determined by a general volumetric measurement described below. Specifically, a carbon gel is placed into a container and cooled down to liquid nitrogen temperature (−196° C.). Thereafter, nitrogen gas is introduced into the container and the amount of the nitrogen gas adsorbed on the carbon gel is determined on the basis of the volumetric method. Subsequently, the pressure of nitrogen gas introduced in the container is gradually changed and the amount of nitrogen gas adsorbed on the carbon gel is plotted against each equilibrium pressure. In this way the nitrogen-adsorption/desorption isotherm is obtained. Using this nitrogen-adsorption/desorption isotherm, the specific surface area and total pore volume can be calculated in accordance with the Subtracting Pore Effect (SPE) method (K. Kaneko, C. Ishii, M. Ruike, H. Kuwabara, Carbon 30, 1075, 1986). The SPE method conducts a micro pore analysis using αₛ-plot method, t-plot method and the like and removes the effects of strong potential fields of micropores to calculate the specific surface area and the like. The SPE method is more accurate than BET method when calculating the specific surface area and the like of microporous materials. Furthermore, the pore size distribution and the pore diameter that corresponds to the peak of the pore size distribution can be provided by BJH analysis of the nitrogen-adsorption/desorption isotherm (Barrett E. P., Joyner L. G., Halenda P. H., Journal of American Chemical Society 73, 373, 1951).

The process for producing the above-described carbon gel according to the present invention is not particularly limited. Where appropriate, publicly known processes can be used to produce the carbon gel according to the present invention. Examples of such processes for producing carbon gels include the following processes.

That is, organic gel is firstly prepared in accordance with the process described in, for example, R. W. Pekala et al., J. Non-cryst. Solids, vol. 145, p. 90 (1992). Specifically, phenols such as resorcinol are reacted with aldehyde such as formaldehyde in the presence of alkaline catalyst or acid catalyst, followed by maturation. In this way organic gel composed of phenol resin is provided. Next, the resultant organic gel is dried and then calcined under inert atmosphere, whereby the organic gel is carbonized. Thus, the carbon gel according to the present invention can be provided.

(Nitrogen-Containing Carbon Gel)

As described above, the carbon gel used as a carrier in the present invention is basically composed of carbons. However, a nitrogen-containing carbon gel in which at least the near-surface portion is composed of nitrogen-containing carbon may be used. If at least the near-surface portion of the carbon gel according to the present invention is composed of nitrogen-containing carbon, the amount of adsorbed components tends to be increased and the adsorbed components tend show excellent stability and activity.

The upper limit of the ratio of nitrogen atoms to carbon atoms (N/C) in such nitrogen-containing carbon is preferably 0.4, and more preferably 0.3. Meanwhile, the lower limit thereof is preferably 0.01, and more preferably 0.05. If the ratio of nitrogen atoms to carbon atoms (N/C) is less than 0.01, the number of nitrogen atoms decreases and thereby its function as an adsorption site that can interact with adsorbed components is decreased. For this reason, there is a tendency that an increase in the adsorptivity by nitrogen atoms cannot be provided. Meanwhile, if the ratio of nitrogen atoms to carbon atoms (N/C) is greater than 0.4, the strength of the carbon framework is reduced and it becomes difficult to maintain pore structures. Thus, the specific surface area is reduced and thereby the adsorptivity tends to be reduced. Note that, the ratio of nitrogen atoms to carbon atoms (N/C) in this kind of nitrogen-containing carbons can be determined by CHN elemental analysis or XPS.

The process for producing a carbon gel that contains nitrogen-containing carbon as described above is not particularly limited, and publicly known processes can be appropriately used to obtain such a carbon gel. Examples of processes for producing such a nitrogen-containing carbon gel includes: (i) a process for introducing nitrogen atoms into carbon frameworks constituting a carbon gel by means of nitric monoxide; and (ii) a process for depositing nitrogen-containing carbon onto the surface of a carbon gel by the thermal CVD process. These processes will be described below.

Firstly, a description will be provided for (i) the process for introducing nitrogen atoms into carbon frameworks constituting a carbon gel by means of nitric oxide (NO).

The introduction of nitrogen atoms into carbon frameworks constituting a carbon gel as described above can be conducted in accordance with the process described in, for example, P. Chambrion et al., Energy & Fuels vol. 11, p. 681-685 (1997). Specifically, a carbon gel is placed into a silica (quartz) reaction tube and heated to about 950° C. under helium gas flow. Thereafter, NO diluted with helium (concentration: about 1000 ppm) is introduced into the reaction tube and thereby the reaction is allowed to proceed at the reaction temperature of about 600-900° C. The reaction time required for the reaction is not particularly limited. However, extension of reaction time increases the amount of nitrogen atoms to be incorporated into carbon frameworks.

Next, a description will be provided for (ii) the process for depositing nitrogen-containing carbon onto the surface of a carbon gel by the thermal CVD process.

This is the process for introducing a nitrogenous organic compound into pores of a carbon gel, thermally decomposing the nitrogenous organic compound and depositing nitrogen-containing carbon onto the surface of the carbon gel. To be more specific, a carbon gel is firstly placed into a reaction tube and heated to a predetermined temperature while introducing inert gas such as nitrogen or argon into the reaction tube. Next, while heating the carbon gel, a gaseous nitrogenous organic compound is introduced into the reaction tube. Thereby, a CVD reaction is allowed to proceed for a certain period of time along with the introduction of the nitrogenous organic compound into pores of the carbon gel. In this way, nitrogen-containing carbon whose framework is constituted of carbon atoms and nitrogen atoms can be deposited in the pores of the carbon gel. In the deposition process of the thermal CVD process, carbon burns when the reaction atmosphere is an oxidizing atmosphere. For this reason, the deposition process is generally performed under inert atmosphere such as nitrogen or argon.

The nitrogenous organic compound used here is not particularly limited as long as it is an organic compound containing a nitrogen atom. For example, nitrogenous heterocyclic compounds, amines, imines and nitriles can be cited. Examples of the nitrogenous heterocyclic compounds include nitrogenous heteromonocyclic compounds and nitrogenous condensed heterocyclic compounds. Examples of nitrogenous heteromonocyclic compounds includes: as five-membered compounds pyrrole and derivatives thereof, diazoles such as pyrazole and imidazole and derivatives thereof, triazoles and derivatives thereof; as six-membered compounds pyridine and derivatives thereof, diazines such as pyridazine, pyrimidine and pyrazine and derivatives thereof, triazines, and triazine derivatives such as melamine and cyanuric acid. In addition, examples of nitrogenous condensed heterocyclic compounds include quinoline, phenanthroline and purine.

Examples of the amines include primary, secondary and tertiary amines, diamines, triamines, polyamines and amino compounds. Examples of primary, secondary and tertiary amines include aliphatic amines such as methylamine, ethylamine, dimethylamine and trimethylamine, aromatic amines such as aniline and derivatives thereof. Examples of diamines include ethylenediamine. Examples of amino compounds include amino alcohols such as ethanolamine. Further, examples of the imines include pyrrolidine and ethyleneimine. Furthermore, examples of the nitriles include aliphatic nitriles such as acetonitrile and aromatic nitriles such as benzonitrile. Moreover, examples of other nitrogenous organic compounds include: polyamides such as nylon; amino sugars such as galactosamine; nitrogenous high molecular compounds such as polyacrylonitrile; amino acids; and polyimides.

When a nitrogenous organic compound is liquid at room temperature at the time of the deposition process of the thermal CVD process, a bubbler, a mass flow pump and the like can be used to vaporize the nitrogenous organic compound and thereby the nitrogenous organic compound turns into gas and is introduced into a reaction tube. At this point, it is preferable to use nitrogen or argon as a carrier gas to introduce the gaseous nitrogenous organic compound into the reaction tube. Furthermore, in order to prevent the gas that has been introduced into the reaction tube from flowing backward through the outlet side of the reaction tube, it is preferable, for example, to place a bubbler or the like provided with liquid paraffin at the outlet side of the reaction tube.

When the nitrogenous organic compound is solid at room temperature, a heat evaporator (sublimator) can be placed at the inlet side of the reaction tube to heat and turn the nitrogenous organic compound into gas before introduced into the reaction tube. At this point, the temperature of the evaporator needs to be adjusted to temperatures at which the nitrogenous organic compound is never thermally decomposed.

In addition, when the nitrogenous organic compound has polymerization characteristics, the following process may be employed: a polymerization reaction is previously allowed to proceed in the pores of a carbon gel and, subsequently, the nitrogenous organic compound is thermally decomposed in the reaction tube under inert atmosphere.

Furthermore, when the nitrogenous organic compound never evaporate by treatment of heat, the nitrogenous organic compound is previously introduced into pores of a carbon gel by using the solution adsorption method or the evaporation-to-dryness method, and then the introduced nitrogenous organic compound is thermally decomposed under inert atmosphere. In this way, nitrogen-containing carbon whose framework is constituted of carbon atoms and nitrogen atoms can be deposited in the pores of the carbon gel.

The reaction temperature of the deposition process in the thermal CVD process is not particularly limited as long as a temperature at which a nitrogenous organic compound is thermally decomposed and carbonized is set. The reaction temperature is preferably 300 to 1,000° C., more preferably in a range of 500 to 700° C. If the reaction temperature is below 300° C., thermal decomposition of the nitrogenous organic compound is less likely to take place and thereby the deposition rate of the nitrogen-containing carbon is reduced. For this reason, the reaction time and energy consumption tend to be increased. Meanwhile, if the reaction temperature exceeds 1,000° C., nitrogen atoms are less likely to remain in the carbon frameworks, and the atomic ratio (N/C) tends to be reduced.

In such a deposition process, the amount of nitrogen-containing carbon to be deposited in pores of a carbon gel is not particularly limited. However, when it is assumed that the specific surface area per 1 g of a carbon gel is Y m², the deposition amount is preferably (0.0001×Y) g or more. If the deposition amount of nitrogen-containing carbon is less than (0.0001×Y) g, the deposition amount is small. For this reason, there is a tendency that an increase in the adsorptivity by nitrogen atoms cannot be provided.

In addition, the deposition amount correlates with the CVD reaction time, and it is possible to control the deposition amount by adjusting the CVD reaction time. Furthermore, although the deposition amount varies depending on, for example, the CVD reaction temperature, the type of carbon gels, the type of nitrogenous organic compounds and the flow amount of a nitrogenous organic compound at the time of introducing it into a reaction tube, it is possible to control the deposition amount by appropriately adjusting the CVD reaction time in any case.

(Carbon Gel Composite Material)

The carbon gel composite material of the present invention includes the above-described carbon gel (including the nitrogen-containing carbon gel) as a carrier, and at least one component (adsorbed component) selected from the group consisting of proteins, metal complexes and metals, which is adsorbed on the carrier.

Firstly, the carbon gel composite material of the present invention, onto which proteins are adsorbed, will be described. The protein used here is not particularly limited, and examples thereof include various types of electron transfer proteins, various types of oxidoreductases, various types of transferases, hydrolases such as proteases (e.g., subtilisin and lipase), lyases such as carboxylyase and aldehydelyase, various types of isomerases and ligases. Among these proteins, at least one protein selected from the group consisting of electron transfer proteins and oxidoreductases is preferable because such proteins can donate or receive electrons efficiently. Examples of such electron transfer proteins include cytochrome C and ferredoxin. In addition, examples of oxidoreductases include: (i) as oxidoreductases using an electron transfer protein as an electron receiver or an electron donor, ferredoxin-NADP reductase, cytochrome C oxidase and the like; (ii) as oxidoreductases using an electron transfer molecule (e.g., coenzymes, methylbiologens and ABTS) as an electron receiver or an electron donor, laccase, diaphorase, lipoxy-amide dehydrogenase, alcohol dehydrogenase, glucose oxidase (including oxidases using other sugars as a substrate) and glucose dehydrogenase (including dehydrogenases using other sugars as a substrate); and (iii) as other oxidoreductases, manganese peroxidase and the like.

With respect to the carbon gel composite material of the present invention, the amount of protein adsorbed on the carbon gel is not particularly limited as long as it shows an enzymatic activity. However, the amount of protein adsorbed on the carbon gel is preferably about 0.01 to 80 weight parts relative to 100 weight parts of the carbon gel in light of the fact that protein can show sufficient activity in the resulting carbon gel composite material.

In addition, the process for providing the carbon gel composite material of the present invention by causing protein to adsorb on a carbon gel is not particularly limited. It is possible to use, for example, the sulimation method and the impregnation method. The impregnation method described below is more preferable. That is, protein is firstly dissolved in water or a buffer at a concentration at which the protein is not precipitated (preferably at a concentration of 0.1 to 1,000 mg/ml). A carbon gel is then suspended into the resultant solution at a temperature at which the solution does not freeze and at which the protein does not denature (preferably 0 to 50° C.) Thus, the protein is brought in contact with the carbon gel for at least 5 minutes or more, preferably for 30 minutes or more and thereby the protein is immobilized in the pores of the carbon gel. In this way, the carbon gel composite material of the present invention can be provided.

The concentration of a carbon gel suspended in the solution is not particularly limited. However, the concentration is preferably about 0.1 to 1,000 mg/ml. In addition, a process for separating and collecting the carbon gel composite material from the solution by centrifugation or the like, and additionally a process for obtaining the carbon gel composite material in which liquid components are removed by drying or the like may be provided after the adsorption process.

Next, a description will be provided for the carbon gel composite material of the present invention, on which metal complex is adsorbed.

The metal complex used here is not particularly limited, and preferable examples thereof include metal complexes composed of at least one central metal selected from the group consisting of Pt, Pd, Ru, Os, Ir, Rh, Au, Fe, Ni, Cr, Mn, Co, Cu, Ti, Zn and V, and of organic ligands. Such organic ligands are also not particularly limited, and examples thereof include porphyrin, phthalocyanine, salen and bipyridyl.

With respect to the carbon gel composite material of the present invention, the amount of metal complex adsorbed on the carbon gel is not particularly limited. However, the amount of metal complex adsorbed the on a carbon gel is preferably about 0.1 to 40 weight parts relative to 100 weight parts of the carbon gel in light of the fact that metal complex can show sufficient activity in the resulting carbon gel composite material.

In addition, the process for providing the carbon gel composite material of the present invention by causing metal complex to adsorb on a carbon gel is not particularly limited. For example, the following process is suitably employed: that is, firstly, a solution in which the metal complex is dissolved and/or dispersed in a solvent is prepared, and a carbon gel is then suspended in the solution and thereby the metal complex in the solution is allowed to adsorb on the carbon gel. In this way, the carbon gel composite material of the present invention can be provided.

The solvent used here is not particularly limited as long as it can dissolve and/or disperse metal complexes. Examples thereof include: nitrites solvent such as propionitrile; chlorinated solvent such as dichloromethane and chloroform; alcohols solvent such as methanol, ethanol and 1-buthanol; alkylketone solvent such as acetone and 2-buthanone; aromatic hydrocarbons such as benzene, toluene and xylene; ethers solvent such as tetrahydrofuran and dioxane; and esters solvent such as ethyl acetate.

The concentration of metal complex in the solution is not particularly limited. However, the concentration is preferably about 0.1 to 30 mM. When a carbon gel is dissolved and/or dispersed into the solution, the concentration of the carbon gel is not particularly limited. However, the concentration is preferably about 0.1 to 35 mg/ml.

The adsorption process for allowing metal complex to adsorb on a carbon gel, the adsorption conditions and the like are not particularly limited. For example, metal complex can be adsorbed on a carbon gel by placing the carbon gel into a solution and stirring and mixing the solution for a certain period of time at about 10 to 100° C. In addition, a process for separating and collecting the carbon gel composite material from the solution by centrifugation or the like, and additionally a process for obtaining the carbon gel composite material in which liquid components are removed by drying or the like may be provided after the adsorption process.

Next, a description will be provided for the carbon gel composite material of the present invention, on which metal is adsorbed. The metal used here is not particularly limited, and various types of noble metals and basic metals are used. These metals may be adsorbed on carbon gels in the form of metallic fine particles or metal ions.

Firstly, a description will be provided for the carbon gel composite material on which the metal is adsorbed in the form of metallic fine particles. The metal used in this case is not particularly limited, and any metal that forms fine particles may be used. However, at least one metal selected from the group consisting of Pt, Pd, Ru, Os, Ir, Rh, Au, Fe, Ni, Cr, Mn, Co, Cu, Ti, Zn and V is preferable. Among these metals, at least one noble metal selected from the group consisting of Pt, Pd, Ru, Os, Ir, Rh and Au is preferable in view of, for example, the enzymatic activity.

The average particle diameter of metallic fine particles of the carbon gel composite material of the present invention is also not particularly limited. However, the average particle diameter is preferably 10 nm or less, more preferably 1 to 5 nm. In addition, the amount of metallic fine particles adsorbed on the carbon gel of the carbon gel composite material of the present invention is not particularly limited. However, the amount of metallic fine particles adsorbed on the carbon gel is preferably about 0.1 to 70 weight parts relative to 100 weight parts of the carbon gel in light of the fact that metallic fine particles can show sufficient activity in the resulting carbon gel composite material.

Moreover, the process for providing the carbon gel composite material of the present invention by causing metallic fine particle to adsorb on a carbon gel is not particularly limited. For example, the following process is suitably employed. Specifically, a solution containing metal (preferably in the form of metallic salt) that constitutes the metallic fine particles is firstly prepared. And then a suspension containing a carbon gel and the metallic solution is prepared, followed by stirring and mixing. Thereafter, a reducing agent is added to the resultant solution and thereby the metal is reduced and deposited onto the surface of the carbon gel. In this way, the carbon gel composite material of the present invention, on which metallic fine particles are adsorbed, can be provided.

The solvent used here is not particularly limited, any solvent that dissolves the metals (preferably in the form of metallic salt) may be used. However, it is preferable to use water. In addition, the reducing agent is also not particularly limited, and a publicly known reducing agent including: a hydrogen compound such as hydrogen peroxide and sodium borohydride; a phosphorus compound such as a hypophosphorous compound; a sulfur compound such as sodium sulfide; and a hydrazine derivative such as hydrated hydrazine, can be appropriately selected and used.

The concentration of metal in the suspension is not particularly limited. However, the concentration is preferably about 0.01 to 100 mM. In addition, the concentration of a carbon gel in the suspension is also not particularly limited. However, the concentration is preferably about 0.01 to 50 mg/ml.

The adsorption process for allowing metal in the suspension to adsorb on a carbon gel, the adsorption conditions and the like are not particularly limited. For example, the metal can be adsorbed on the carbon gel by stirring the suspension for a certain period of time at about 20 to 100° C. In addition, a process for separating and collecting the carbon gel composite material from the solution by centrifugation or the like, and additionally a process for obtaining the carbon gel composite material in which liquid components are removed by drying or the like may be provided after the adsorption process. Furthermore, the process for reducing metal adsorbed on a carbon gel composite material, the reduction conditions and the like are not particularly limited. For example, the following process is suitably employed: reducing a carbon gel composite material for a certain period of time at about 150 to 300° C. under hydrogen flow.

Next, a description will be provided for the carbon gel composite material on which the metal is adsorbed in the form of metal ions. For the metal ions used in this case, any metal ions that can form coordinate bonds with nitrogen atoms in the carbon frameworks may be used, and at least one metal selected from the group consisting of Fe, Ni, Cr, Mn, Co, Cu, Ti, Zn and V is preferable.

With respect to the carbon gel composite material of the present invention, the amount of metal ions adsorbed on the carbon gel is not particularly limited. However, the amount of metal ions adsorbed on the carbon gel is preferably about 0.1 to 50 weight parts relative to 100 weight parts of the carbon gel in light of the fact that metal ions can show sufficient activity in the resulting carbon gel composite material.

In addition, the process for providing the carbon gel composite material of the present invention by causing metal ions to adsorb on a carbon gel is not particularly limited. For example, the following process is suitably employed: that is, a solution is firstly prepared which is obtained by dissolving the metal (preferably in the form of metallic salt) into a solvent. And a carbon gel is then suspended in the resultant solution, thereby allowing the metal ions in the solution to adsorb on the carbon gel. In this way, the carbon gel composite material of the present invention can be provided.

The solvent used here is not particularly limited as long as it can dissolve metals (preferably metallic salts). Examples thereof include: acetic acid, water, ethylene glycol, DMSO and DMF.

The concentration of metal in the solution is not particularly limited. However, the concentration is preferably about 0.01 to 100 mM. In addition, the concentration of the carbon gel dispersed in the solution is also not particularly limited. However, the concentration is preferably about 0.01 to 100 mg/ml.

The adsorption process for allowing metal ions to adsorb on a carbon gel, the adsorption conditions and the like are not particularly limited. For example, metal ions can be adsorbed on a carbon gel by placing the carbon gel into a solution and stirring the solution for a certain period of time at about 25 to 200° C. preferably under vacuum. In addition, a process for separating and collecting the carbon gel composite material from the solution by centrifugation or the like, a process for obtaining the carbon gel composite material in which liquid components are removed by drying or the like, and furthermore, a process for subjecting the carbon gel composite material to a heat treatment for a certain period of time at 400 to 1,000° C. under inter atmosphere (e.g., Ar) may be provided after the adsorption process.

The use of the carbon gel composite material of the present invention is not particularly limited. For example, the carbon gel composite material of the present invention can be employed in various applications including catalysts and the like, and can be used in a way that is general in the fields.

### EXAMPLES

Hereinafter, the present invention will be described more specifically on the basis of Examples and Comparative Examples. However, the present invention is not limited to the examples described below.

### Synthesis Examples 1 to 4

Firstly, organic gel was prepared in accordance with the process described in R. W. Pekala et al., J. Non-cryst. Solids, vol. 145, p. 90 (1992). To be more specific, 5.5 g of resorcinol (manufactured by Wako Pure Chemical Industries, Ltd) and 26.5 mg of sodium carbonate (manufactured by Wako Pure Chemical Industries, Ltd) were dissolved into 16.9 g of distilled water, and 8.1 g of 37% formaldehyde aqueous solution (manufactured by Wako Pure Chemical Industries, Ltd) was added in the solution, followed by stirring and mixing. The resultant mixture solution was light yellow and transparent. Note that, the molar ratio of the components is as follows:

Resorcinol: sodium carbonate: formaldehyde=200:1:400

Next, the mixture solution thus prepared was diluted with water and, while controlling the pore diameter, organic gels were obtained. To be more specific, in addition to the prepared mixture solution described above, solutions obtained by diluting the mixture solution with water (3 to 12 fold dilution (volume ratio)) were prepared (Synthesis Example 1: undiluted, Synthesis Example 2: 3-fold dilution, Synthesis Example 3: 6-fold dilution, Synthesis Example 4: 12-fold dilution). These solutions were poured into vials, and the vials were sealed hermetically. Subsequently, these vials were allowed to stand for 24 hours at room temperature, for 24 hours at 50° C. and for 72 hours at 90° C. In this way, hydrated organic gels were provided.

Next, the organic gels thus obtained were dried in the following way. Specifically, the hydrated organic gels were firstly soaked in acetone (manufactured by Wako Pure Chemical Industries, Ltd), an exchange solvent, in order to remove water in the organic gels. As water present in the organic gels dispersed into acetone, water present in the organic gels was completely replaced with acetone. At this point, acetone, an exchange solvent, was replaced with new one for several times. Thus, the replacement ratio of water was further increased. Subsequently, the solvent for soaking was changed to n-pentane (manufactured by Wako Pure Chemical Industries, Ltd), and rounds of the solvent exchange/soaking process were similarly repeated until acetone present in the organic gels were completely replaced with n-pentane. The organic gels in which the solvent is replaced with n-pentane were then air-dried. In this way dried organic gels were provided.

Next, the dried organic gels thus obtained were carbonized in the following way and thereby carbon gels were provided. To be more specific, the dried organic gels were heated at 1,000° C. under nitrogen flow (flow rate 300 ml/min) and thus the organic gels were carbonized. Note that, the heating time was 6 hours.

### Comparative Synthesis Example 1

One-dimensional mesoporous carbon (MPC) was synthesized as follows: that is, 4 g of triblock copolymer (Pluonic P123) was firstly added to 30 ml of water and it is stirred for 3 hours, and thereby a homogeneous solution was obtained. To this solution, 120 ml of 2M HCl aqueous solution was added and the solution was further stirred for 2 hours. 9 g of tetraethylorthosilicate was added to this solution followed by stirring at 313K for 24 hours. After stirring, the resultant solution was allowed to stand at 373K for 48 hours. Thus, a solid matter was deposited.

Next, the produced solid matter was removed by filtration and washed thoroughly with ion-exchanged water. Thereafter, the solid matter was dried in the air at 373K. The resultant dried sample was further calcined in the air at 823K and thereby the organic matter (P123) was decomposed and removed. In this way, a silica mesoporous material (SBA-15), a pore template, was provided.

Next, 1.25 g of sucrose dissolved into 5 g of water, and 0.14 g of sulfuric acid were added to 1 g of the obtained silica mesoporous material (SBA-15) and mixed. Then, the resultant mixture was heated at 373K for 6 hours and then at 433K for 6 hours. The dehydrating action of sulfuric acid carbonized a part of sucrose to give brown powders. To this reactant, 0.3 g of sucrose dissolved into 5 g of water, and 0.03 g of sulfuric acid were further added and mixed. In accordance with the above-described operation, the resultant solution was heated at 373K for 6 hours and then heated at 433K for 6 hours. The resultant powders were heated at 1173K under nitrogen flow and thereby sucrose present in the pores were completely carbonized.

The silica mesoporous material-carbon complex thus obtained was treated with 5 wt % of hydrogen fluoric acid at room temperature. In this way only silica components were dissolved therein, providing a one-dimensional mesoporous carbon (MPC).

[X-Ray Diffraction (XRD) Measurement]

The X-ray diffraction measurement was made for the carbon gels prepared in the Synthesis Examples 1 to 4 and for the mesoporous carbon prepared in the Comparative Synthesis Example 1. With respect to the carbon gels prepared in the Synthesis Examples 1 to 4, no X-ray diffraction peaks were observed over a scan angle (2θ) range of 0.5 to 10° (CuK_{α}radiation). This confirmed that pores of the carbon gels prepared in the Synthesis Examples 1 to 4 are not periodically arranged but constitute a three-dimensional network structure in which pores are connected to each other.

By contrast, with respect to the mesoporous carbon prepared in the Comparative Synthesis Example 1, a main peak was observed at 2θ of 0.96° and, weak peaks were at 2θ of 1.68° and 1.94°. These peaks are derived from a two-dimensional hexagonal structure (p6 mm) and are respectively attributed to (100), (110) and (200) diffractions. The d values of these peaks are 9.1 nm, 5.2 nm and 4.6 nm, respectively. In addition, since the X-ray diffraction peaks were also observed in the SBA-15 which is a template, it was confirmed that the pore structure of the SBA-15 was reflected upon the structure of the mesoporous carbon prepared in the Comparative Synthesis Example 1. The two-dimensional hexagonal structure is known to be formed of the arrangement of cylinder pores. This confirmed that the mesoporous carbon prepared in the Comparative Synthesis Example 1, reflecting the pore structure of the SBA-15, has one-dimensional pores.

[Measurement of Pore Size Distribution and the Like]

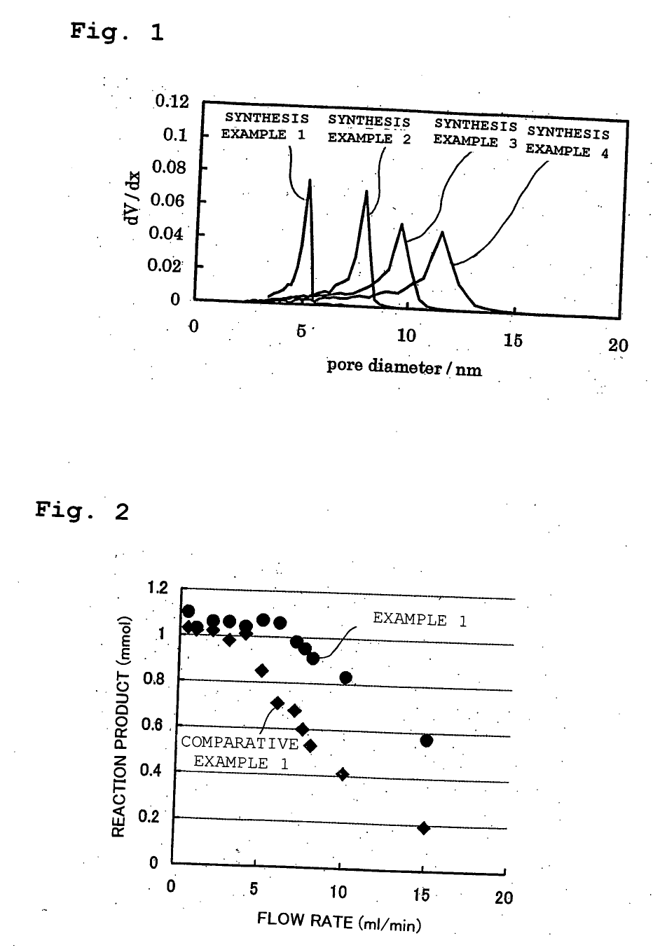

The nitrogen adsorption/desorption measurement was made for the carbon gels prepared in the Synthesis Examples 1 to 4. Based on the obtained nitrogen-adsorption/desorption isotherm, pore size distribution of the carbon gels was calculated. The obtained result is as shown in FIG. 1. All of the carbon gels prepared in the Synthesis Examples 1 to 4 had a pore diameter in a range of 2 to 15 nm. In addition, the shape of the distribution confirmed that all of the carbon gels had a highly uniform pore diameter, where if a pore diameter corresponding to the peak of the pore size distribution is not smaller than 1 nm and is smaller than 10 nm (pore diameter (d)), pores accounting for 60% or more of the total pore volume have a pore diameter within plus or minus 2 nm of the pore diameter (d), and if a pore diameter corresponding to the peak of the pore size distribution is in a range of 10 to 50 nm (pore diameter (D)), pores accounting for 60% or more of the total pore volume have a pore diameter in a range of (0.75×D) to (1.25×D). Meanwhile, the pore diameters of the carbon gels prepared in the Synthesis Examples 1 to 4, each corresponding to the peak of its pore size distribution, and the average particle diameters of the primary particles thereof were as shown in Table 1.

Similarly, the pore size distribution was measured for the mesoporous carbon prepared in the Comparative Synthesis Example 1. The shape of the distribution was similar to that of the carbon gel prepared in the Synthesis Example 2, and the pore diameter corresponding to the peak of the pore size distribution was 7.5 nm.

TABLE 1

| | | The pore diameter | |
|---|---|---|---|
| | Dilution | corresponding to | |
| | range | the peak of the | Average particle |
| | (volume | pore size | diameter of primary |
| | ratio) | distribution(nm) | particles (nm) |
| Synthesis example 1 | undiluted | 5.2 | 7.9 |
| Synthesis example 2 | 3-fold | 7.4 | 8.2 |
| Synthesis example 3 | 6-fold | 8.7 | 8.3 |
| Synthesis example 4 | 12-fold | 11.5 | 8.5 |
| Comparative | — | 7.5 | — |
| Synthesis example 1 | | | |

### Example 1 and Comparative Examples 1 and 2

As an enzyme, manganese peroxidase from Phanerochaete chrysosporium (MnP, molecular diameter: 6.8 nm) was dissolved into distilled water. Thus, an enzyme solution with an enzyme concentration of 1 mg/ml was prepared. Next, as a porous material, the carbon gel prepared in the Synthesis Example 2 was used in the comparative example 1, and the mesoporous carbon (MPC) prepared in the Comparative Synthesis Example 1 was used in the Comparative Example 1. 10 ml of the enzyme solution was added to 200 mg of each porous material. The resultant mixtures were gently stirred overnight at 4° C. in order to immobilize enzyme to the respective porous materials. The porous materials immobilized with enzyme in this way were separated and collected from the respective enzyme solutions by centrifugation, followed by three rounds of washing with 5 ml of distilled water (wash solution).

[Measurement of the Immobilized Amount and Elution Amount of Enzyme]

The amount of enzyme present in the enzyme solutions was measured on the basis of the absorbance at 280 nm both prior to and subsequent to enzyme immobilization. Based on the result, the amount of enzyme immobilized on the resultant porous materials was calculated. In addition, the amount of enzyme eluted in the wash solution was similarly measured. The obtained result is shown in Table 2.

As apparent from the result shown in Table 2, a sufficient amount of enzyme (MnP) was immobilized on both the carbon gel prepared in the Synthesis Example 2 and the mesoporous carbon prepared in the Comparative Synthesis Example 1. The elution amount was also almost equal between the examples.

TABLE 2

| | Porous material | | | |
|---|---|---|---|---|
| | (The pore diameter | | | |
| | corresponding to the | Immobilized | Eluted | Elution |
| | peak of the pore size | amount | amount | ratio |
| | distribution(nm)) | (mg) | (mg) | (%) |
| Example 1 | Synthesis example 2 | 9.8 | 0.2 | 2.0 |
| | (7.4 nm) | | | |
| Comparative | Comparative Synthesis | 9.7 | 0.1 | 1.1 |
| example 1 | example 1 (7.5 nm) | | | |

[Thermal Stability Test for the Immobilized Enzyme]

The thermal stability of enzyme (MnP) immobilized on the porous materials (Example 1 and Comparative Example 1) and of the enzyme solution (Comparative Example 2) was evaluated in the following manner. Specifically, porous materials immobilized with 10 mg of enzyme were respectively suspended in 0.5 ml of 50 mM succinate buffer (pH 4.5) followed by heat treatment at 60° C. for a certain period time (30 or 60 minutes) Thereafter, the resultant solutions were placed in ice for full cooling and the porous materials were collected by centrifugation (Example 1 and Comparative Example 1).

Similarly, an enzyme solution was prepared by dissolving MnP into 50 mM succinate buffer (pH 4.5) at a concentration of 1 mg/ml. The enzyme solution was subjected to a heat treatment at 60° C., followed by full cooling in ice (Comparative Example 2).

Next, 1 ml of a substrate solution (0.5 mM MnSO₄, 2 mM sodium oxalate, 0.1 mM H₂O₂, 25 mM succinate buffer (pH 4.5)) was added to the porous materials and the enzyme solutions, and they were stirred at 37° C. for 15 minutes. Thereafter, the resultant solutions were cooled and the absorbance at 270 nm of each supernatant was measured to determine the remaining activity. It should be noted that the absorbance at 270 nm of each sample that had not been subjected to a heat treatment at 60° C. was similarly measured to determine the remaining activity, a relative activity with respect to the activity before heat treatment. The obtained result is shown in Table 3.

As apparent from the result shown in Table 3, while almost all enzymes in the solution prepared in the Comparative Example 2, where enzyme was not immobilized on a porous material, were deactivated by a 30 minute-heat treatment. On the contrary, both the enzyme immobilized on the carbon gel prepared in the Synthesis Example 2 and the enzyme immobilized on the mesoporous carbon prepared in the Comparative Synthesis Example 1 showed a sufficiently high thermal stability.

TABLE 3

| | Porous material | | |
|---|---|---|---|
| | (The pore diameter | | |
| | corresponding to the | | |
| | peak of the pore size | Remaining activity (%) | |
| | distribution(nm)) | 30 min | 60 min |
| Example 1 | Synthesis example 2 | 86 | 75 |
| | (7.4 nm) | | |
| Comparative | Comparative Synthesis | 88 | 73 |
| example 1 | example 1 (7.5 nm) | | |
| Comparative | No enzyme immobilized | 8 | 0 |
| example 2 | | | |

[Specific Activity Test for the Immobilized Enzyme]

As a porous material, the carbon gel prepared in the Synthesis Example 2 was used in the example 1, and the mesoporous carbon (MPC) prepared in the Comparative Synthesis Example 1 was used in the Comparative Example 1. In accordance with the above-described operation, samples were obtained in which 50 mg of enzyme (MnP) is immobilized on 100 mg of the porous materials. Next, the porous materials with immobilized enzyme were filled in glass columns (5 mmφ), and substrate solutions (0.5 mM MnSO₄, 2 mM sodium oxalate, 0.1 mM H₂O₂, 25 mM succinate buffer (pH 4.5)) were allowed to flow through the glass columns at various flow rates, thereby causing reactions to occur sequentially at 37° C. The apparent reaction activity was evaluated by determining, on the basis of the absorbance at 270 nm, the amount of the reaction product contained in the reaction solution eluted from the column in 1 minute. The obtained result is shown in FIG. 2.

As apparent from the result shown in FIG. 2, the reaction activity in the mesoporous carbon (Comparative Example 1) was almost similar to that in the carbon gel (Example 1) over the low flow rate region. However, as the flow rate of the substrate increases, the amount of the reaction product gradually decreased in the case of the mesoporous carbon (Comparative Example 1). Meanwhile, in the case of the carbon gel (Example 1), the initial activity was also generally maintained over this flow rate region. Thus, it was confirmed that this carbon gel is excellent in the activity.

Note that, with respect to enzyme immobilized on porous materials, not only the activity of the enzyme itself but the diffusion of substrates and the diffusion inside pores of reaction products significantly influences its apparent reaction activity. In this experiment the activity over the low flow rate region was almost similar in every case, leading to the conclusion that the activity of the immobilized enzyme itself was similar in every case. However, since the apparent activities were different over the high flow rate region where diffusion of substrates and the like is the rate-determining step in the reaction, diffusion of substrates and reaction products occurs more efficiently in the three-dimensional pores formed in the carbon gel compared to the one-dimensional pores formed in the mesoporous carbon. This leads to the conclusion that the carbon gel (Example 1) offered higher reactivity over the high flow rate region.

### Example 2

In an aqueous solution, 1.5 g of hexahydroxyplatinic acid was dispersed and 100 ml of 6% aqueous solution of sulfurous acid (H₂SO₃) was added. The resultant mixture was then stirred for 1 hour. Thereafter, the resultant dispersion was soaked in a 120° C. oil bath for removal of residual sulfurous acid, and cooled down to give a Pt solution (Pt concentration: 4 g/L).

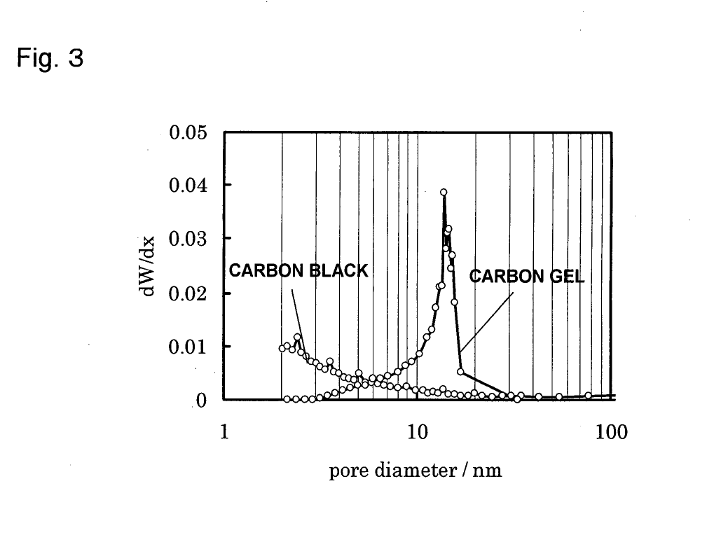

Next, 3 g of the carbon gel prepared in the Synthesis Example 4 (specific surface area: 760 m²/g, pore size distribution: shown in FIG. 3, and the pore diameter that corresponds to the peak of the pore size distribution: 11.5 nm) was measured in 187 ml of the Pt solution, and 20% H₂O₂ aqueous solution was added to the Pt solution. Then, the resultant mixture was soaked in a 120° C. oil bath to allow Pt to adsorb on the carbon gel. The carbon gel on which Pt is adsorbed in this way was subjected to filtration, drying and pulverization processes, followed by reduction under hydrogen flow at 150 to 500° C. (preferably 200 to 400° C.) for 1 to 3 hours. Thus, Pt/carbon gel catalyst (A) on which Pt is adsorbed on the carbon gel was obtained.

Next, the weight of the thus obtained Pt/carbon gel catalyst (A) was measured. The Pt/carbon gel catalyst (A) was mixed with a Nafion solution (produced by Sigma-Aldrich Corp., solvent: mixed solvent of ethanol and water, polymer content: 5 wt %) so that the weight of the carbon gel in the catalyst becomes equal to the weight of the polymer solids in the Nafion solution. The resultant mixture was further mixed to give a catalyst ink (A). The catalyst ink (A) was applied on a Teflon (registered trademark) sheet in a way that the amount of Pt was 0.3 mg/cm². The obtained sheet was dried to give a catalyst sheet (A). The catalyst sheet (A) was then attached to one surface of Nafion112 membrane (produced by DuPont Corp., thickness: about 50 μm) by thermocompression. Subsequently, the Teflon sheet was removed, and a cathode catalyst layer was transferred on the surface of the Nafion membrane.

Meanwhile, the procedure for providing the Pt/carbon gel catalyst (A) was followed to prepare a Pt/carbon black catalyst (B), with the exception that carbon black (produced by Lion Corp., Ketjen Black, specific surface area: 800 m²/g, pore size distribution: shown in FIG. 3) was used instead of the foregoing carbon gel. Next, the procedure for providing the catalyst sheet (A) was followed to prepare a catalyst sheet (B), with the exception that the Pt/carbon black catalyst (B) was used instead of the Pt/carbon gel catalyst (A) and that the amount of Pt was adjusted to 0.1 mg/cm². Then, the procedure for providing the cathode catalyst layer was followed to transfer the catalyst sheet (B) on the opposite surface of the Nafion112 membrane, where the Nafion112 membrane is not formed. In this way an anode catalyst layer was formed.

Using the thus prepared Membrane-Electrode Assembly (hereinafter referred to as “MEA”), a compact fuel cell (electrode area: 13 cm²) was fabricated.

### Example 3

The procedure in the Example 2 was followed to prepare MEA with the exception that a carbon gel that has a specific surface area of 640 M²/g and where the pore diameter that corresponds to the peak of the pore size distribution is 30 nm and the primary particles have an average particle diameter of 8.5 nm was used. Using this MEA, a compact fuel cell was fabricated. It should be noted that in the carbon gel, no x-ray diffraction peaks were observed over a scan angle (2θ) range of 0.5 to 10° (CuK_{α}radiation).

### Comparative Example 3

The procedure in the Example 2 was followed to prepare MEA with the exception that mesoporous carbon (specific surface area: 780 m²/g) prepared in the Comparative Synthesis Example 1 was used instead of the foregoing carbon gel. Using this MEA, a compact fuel cell was fabricated.

### Comparative Example 4

The procedure in the Example 2 was followed to prepare MEA with the exception that instead of the Pt/carbon gel catalyst (A), the Pt/carbon black catalyst (B) was used as a cathode side catalyst. Using this MEA, a compact fuel cell was fabricated.

[Electricity-Generating Performance of the Compact Fuel Cells]

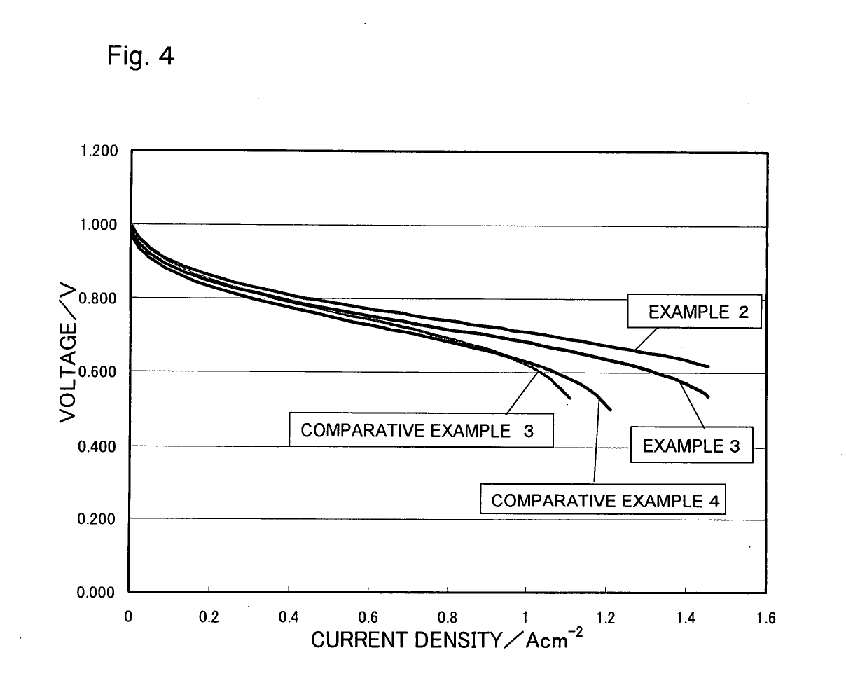

Discharge test of the compact fuel cells prepared in the Examples 2 and 3 and Comparative Examples 3 and 4 were conducted in the following way. Specifically, using pure hydrogen gas with a dew point of 75° C. (pressure: 0.15 Mpa, flow rate: 100 mL/min) as an anode gas, and air with a dew point of 65° C. (pressure: 0.15 Mpa, flow rate: 500 mL/min) as a cathode gas, discharge tests were conducted under the condition where the cell temperature was kept at 80° C. In that way, the relationship between the discharge current and cell voltage (I-V characteristics) was investigated. FIG. 4 shows the obtained result.

As apparent from the result shown in FIG. 4, it was confirmed that the fuel cells using the carbon gel composite material of the present invention as an electrode catalyst (Examples 2 and 3) showed higher voltage characteristics than those prepared in the Comparative Examples 3 and 4. The present inventors cite the following factors as reasons why such high voltage characteristics were achieved in the carbon gel composite material of the present invention.

(i) Since the mesoporous carbon used in the Comparative Example 3 has one-dimensional pore arrangement, if the entrances of the pores are blocked by Nafion or water produced as a result of the reaction in the fuel cell, it is more likely that provision of reactants (e.g., oxygen) is inhibited. Since the carbon gel according to the present invention, on the other hand, has pores constituting a three-dimensional network structure, it is less subject to the influence of pore blocking.

(ii) When carbon black is used in the Comparative Example 4, Pt catalyst is not basically adsorbed inside pores with a pore diameter of 1 nm or less, which make up a substantial proportion of the surface area of the carbon black. Even when Pt catalyst is adsorbed inside such pores, Nafion cannot enter the pores, thus resulting poor utilization of Pt. For this reason, in carbon black, the surface area on which Pt is virtually adsorbed is reduced, when compared to a carbon gel with a carrier-surface area of the same size, resulting a reduction in the voltage characteristics.

### Example 4

A carbon gel (specific surface area: 680 m²/g, the pore diameter corresponding to the peak of the pore size distribution: 3 nm, and the average particle diameter of the primary particles: 8.2 nm) was measured into a flask. Next, a Co-tetraphenylporphyrin(CoTPP)/tolurene solution (concentration: 2.9 mg/L) was prepared. Then, this solution was added in the flask in an amount of 400 ml per 1 g of the carbon gel. The resultant dispersion was then placed into a water bath at 50° C. under a reduced pressure to remove the solvent, followed by further dying at 100° C. overnight. Thereafter, the dried material was collected and pulverized to prepare a CoTPP/carbon gel (A) catalyst where CoTPP is adsorbed on the carbon gel. It should be noted that in the carbon gel, no x-ray diffraction peaks were observed over a scan angle (2θ) range of 0.5 to 10° (CuK_{α}radiation).

### Example 5

The procedure in the Example 4 was followed to prepare a CoTPP/carbon gel (B) catalyst, with the exception that the carbon gel prepared in the Synthesis Example 1 (specific surface area: 640 m²/g, and the pore diameter corresponding to the peak of the pore size distribution: 5.2 nm) was used as a carbon gel.

### Example 6

The procedure in the Example 4 was followed to prepare a CoTPP/carbon gel (C) catalyst with the exception that the carbon gel prepared in the Synthesis Example 4 (specific surface area: 760 m²/g, and the pore diameter corresponding to the peak of the pore size distribution: 11.5 nm) was used as a carbon gel.

### Comparative Example 5

The procedure in the Example 4 was followed to prepare a CoTPP/carbon black catalyst with the exception that carbon black (produced by Lion Corp., Ketjen Black, specific surface area: 800 m²/g, pore size distribution: shown in FIG. 3) was used instead of the foregoing carbon gel.

[Model Test of Oxidation-Reduction Reaction]

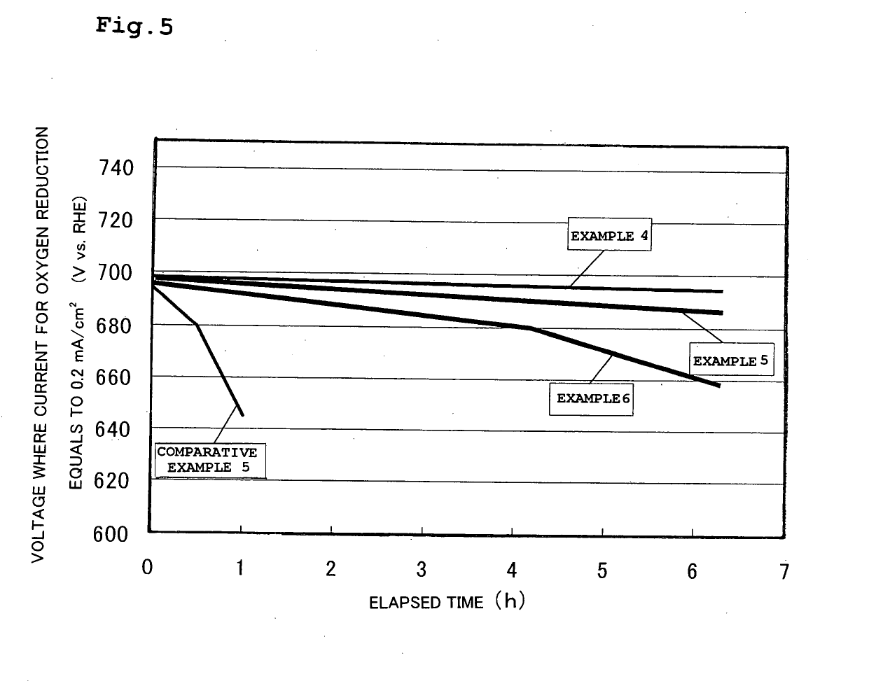

Each of the catalysts prepared in the Examples 4 to 6 and Comparative Example 5 was dispersed and attached on a glassy carbon electrode (GC electrode) to fabricate an electrode (a working electrode). Then, model test for oxygen-reduction reaction was conducted in the following way. FIG. 5 shows the obtained result.

(1) Cell Configuration in the Model Experiments

Test electrode: working electrodes were fabricated in accordance with the procedure described below.

(i) The GC surface of the rotating electrodes (apparent surface area of the GC electrode: 0.20 cm²) was polished to a mirror-smooth state.

(ii) 60 mg of each of the catalysts was mixed with 10 ml of ultrapure water, followed by sonication for 3 minutes.

(iii) After dropping 15 μl of each resultant suspension to the corresponding GC electrode, the GC electrodes were dried in the air at 80° C. for 10 minutes.

(iv) An aliquot of a Nafion/ethanol aqueous solution was dropped on the resultant GC electrodes. After dying the GC electrodes at room temperature for 15 minutes, the GC electrodes were dried in vacuo at 80° C. for 30 minutes. At this time, the amount of Nafion to be applied on the GC electrodes was about 3.2 μg in terms of dried polymer weight.

(v) The resultant GC electrodes were cooled by allowing them to stand outside the furnace. Thereafter, they are attached to respective devices.

Counter Electrode: Pt Plate

Reference Electrode: RHE (Reversible Hydrogen Electrode)

(2) Procedure of Model Experiments

(i) An electrochemical cell containing an electrolyte of a 0.5M aqueous solution of sulfuric acid was soaked into a water bath where the temperature is kept at 25° C.

(ii) The electrolyte was deaerated by bubbling Ar (about 20 minutes or more).

(iii) The voltammogram was recorded at the time when an electrode potential had just finished switching between two values for ten times under the condition as follows: (1) sweep rate: 10 mV/s; (2) sweep range: 50 to 1,000 mV; and (3) the rotational speed of the electrode: 1,000 rpm. At this time, the voltage that had finished switching between two values for ten times was regarded as one cycle.

(iv) The bubbling gas was switched to oxygen, replacing the gas for 30 minutes or more. Subsequently, voltage sweeping was repeated under the condition similar to (iii).

(v) The electrode potential at which the current difference from the voltammogram in Ar was 0.2 mA/cm² or more toward reduction side was determined, and plotted against the time elapsed from the onset of potential scanning under oxygen-saturated conditions.

As apparent from the result shown in FIG. 5, the fuel cell using the carbon black that has a small number of pores capable of accommodating tetraphenylporphyrin (TPP, average molecular diameter: about 1 nm) (Comparative Example 5) caused a rapid reduction in the catalyst activity with increasing time. However, it was confirmed that the fuel cells using the carbon gel composite material of the present invention (Examples 4 to 6) prevented reduction in the catalyst activity. Furthermore, has many pores as large as 1 to 1.25 times the average molecular diameter of a complex (Examples 4 and 5) further increased the stability of catalyst activity.

### INDUSTRIAL APPLICABILITY

As described above, according to the present invention, it is possible to provide a carbon gel composite material that carries a high amount of components such as protein, metal complex or metal and that provides adsorbed components with excellent stability and activity. Accordingly, according to the present invention, it is possible to provide a carbon gel composite material that is useful in various applications including catalysts and the like.

What is claimed is:

1. A carbon gel composite material, comprising:
a carbon gel which is composed of primary particles with an average particle diameter of 2 to 50 nm, where no x-ray diffraction peaks are observed over a scan angle (2θ) range of 0.5 to 10° (CuK_{α}radiation) and where in a pore size distribution calculated from an adsorption/desorption isotherm, if a pore diameter corresponding to the peak of the pore size distribution is not smaller than 1 nm and is smaller than 10 nm (pore diameter (d)), pores accounting for 60% or more of the total pore volume have a pore diameter within plus or minus 2 nm of the pore diameter (d), and if a pore diameter corresponding to the peak of the pore size distribution is in a range of 10 to 50 nm (pore diameter (D)), pores accounting for 60% or more of the total pore volume have a pore diameter in a range of (0.75×D) to (1.25×D); and
at least one adsorbed component selected from the group consisting of proteins, metal complexes and metals, which is adsorbed on the carbon gel.

2. The carbon gel composite material according to claim 1, wherein the pore diameter of the carbon gel, corresponding to the peak of the pore size distribution, is in a range of 1 to 20 nm.

3. The carbon gel composite material according to claim 1, wherein the pore diameter of the carbon gel, corresponding to the peak of the pore size distribution, is 1 to 1.25 times the average molecular diameter of the adsorbed component.

4. The carbon gel composite material according to claim 1, wherein the specific surface area of the carbon gel is 100 m²/g or more.

5. The carbon gel composite material according to claim 1, wherein the total pore volume of the carbon gel is 0.1 to 50 ml/g.

6. The carbon gel composite material according to claim 1, wherein at least one protein selected from the group consisting of oxidoreductases and electron transfer proteins is adsorbed on the carbon gel.

7. The carbon gel composite material according to claim 1, wherein at least near-surface portion of the carbon gel is composed of nitrogen-containing carbon.

8. The carbon gel composite material according to claim 7, wherein the ratio of nitrogen atoms to carbon atoms (N/C) in the nitrogen-containing carbon is 0.01 to 0.4.
